(19) United States
(12) Patent Application Publication
(10) Pub. No.: US 2026/0238540 A1
(43) Pub. Date: Aug. 13, 2026

(54) WIRELESS COMMUNICATION SYSTEM, RECEIVING DEVICE, WIRELESS COMMUNICATION METHOD AND RECEIVING PROGRAM

(71) Applicant: NTT, Inc., Tokyo (JP)

(72) Inventors: Keita KURIYAMA, Musashino-shi, Tokyo (JP); Toshifumi MIYAGI, Musashino-shi, Tokyo (JP); Hitoshi HASEGAWA, Musashino-shi, Tokyo (JP); Kentaro TANAKA, Musashino-shi, Tokyo (JP)

(73) Assignee: NTT, Inc., Tokyo (JP)

(21) Appl. No.: 19/155,592

(22) PCT Filed: Feb. 17, 2023
(86) PCT No.: PCT/JP2023/005789

§ 371 Date: Aug. 12, 2025

(51) Int. Cl. H04L 27/38

(52) U.S. Cl. CPC H04L 27/38

(57) ABSTRACT

In a wireless communication system according to an embodiment, a reception device includes: equalization circuitry configured to perform equalization processing on a pilot signal received from a transmission device; indexing circuitry configured to assign an index predetermined for each signal point of a predetermined constellation to each convergence point of the reception constellation on the basis of each signal point of the predetermined constellation; reference constellation calculation circuitry configured to calculate each center of gravity of each cluster of the convergence points to which the same index has been assigned as a reference constellation to be referred to for demodulating a received signal; estimation circuitry configured to delete a signal point regarded as an outlier and estimate a model indicating distortion of a constellation; correction circuitry configured to correct the constellation by adding the estimated model to an ideal constellation; and demodulation circuitry configured to demodulate the received signal.

### TECHNICAL FIELD

The present invention relates to a wireless communication system, a reception device, a wireless communication method, and a reception program.

### BACKGROUND ART

In the case of modulating and transmitting a digital signal in a wireless communication system, constellation information is shared between a transmission device and a reception device before data communication is started.

Further, in a case where IQ imbalance occurs due to imbalance of a quadrature modulator/demodulator, signals between subcarriers symmetrical about a center frequency interfere with each other, resulting in considerable deterioration of communication quality.

For example, NPL 1 discloses a technique for estimating characteristics of IQ imbalance that has occurred in a quadrature demodulator using a pilot signal inserted in a frequency domain of a system and compensating for mutual interference between subcarriers on the basis of an obtained estimated value.

### CITATION LIST

### Non Patent Literature

[NPL 1] Egashira Yoshimasa et al., “A Novel IQ Imbalance Compensation Method with Pilot-Signals for OFDM System, ” Journal B of the Institute of Electronics, Information and Communication Engineers, Vol. J91-B No.5, The Institute of Electronics, Information and Communication Engineers, 2008, pp.558-565

### SUMMARY OF INVENTION

### Technical Problem

However, conventionally, when a transmission device transmits a control signal for notifying a reception device of distortion characteristics of constellations to the reception device, transmission capacity may be reduced by the control signal.

The present invention has been made in view of the problem described above, and an object of the present invention is to provide a wireless communication system, a reception device, a wireless communication method, and a reception program capable of improving demodulation performance without reducing transmission capacity.

### Solution to Problem

A wireless communication system according to one aspect of the present invention is a wireless communication system in which a reception device demodulates a received signal on the basis of a pilot signal transmitted by a transmission device using a single carrier, wherein the reception device includes: an equalization unit configured to perform equalization processing on the pilot signal received from the transmission device and output a reception constellation; an indexing unit configured to assign an index predetermined for each signal point of a predetermined constellation to each convergence point of the reception constellation on the basis of each signal point of the predetermined constellation; a reference constellation calculation unit configured to calculate each center of gravity of each cluster of the convergence points to which the same index has been assigned by the indexing unit as a reference constellation to be referred to for demodulating the received signal; an estimation unit configured to delete a signal point regarded as an outlier from the reference constellation and estimate a model indicating distortion of a constellation; a correction unit configured to correct the constellation by adding the model estimated by the estimation unit to an ideal constellation; and a demodulation unit configured to demodulate the received signal using the constellation corrected by the correction unit.

Furthermore, a reception device according to one aspect of the present invention includes: an equalization unit configured to perform equalization processing on a pilot signal transmitted from a transmission device using a single carrier and output a reception constellation; an indexing unit configured to assign an index predetermined for each signal point of a predetermined constellation to each convergence point of the reception constellation on the basis of each signal point of the predetermined constellation; a reference constellation calculation unit configured to calculate each center of gravity of each cluster of the convergence points to which the same index has been assigned by the indexing unit as a reference constellation to be referred to for demodulating the received signal; an estimation unit configured to delete a signal point regarded as an outlier from the reference constellation and estimate a model indicating distortion of a constellation; a correction unit configured to correct the constellation by adding the model estimated by the estimation unit to an ideal constellation; and a demodulation unit configured to demodulate the received signal using the constellation corrected by the correction unit.

Furthermore, a wireless communication method according to one aspect of the present invention is a wireless communication method in which a reception device demodulates a received signal on the basis of a pilot signal transmitted by a transmission device using a single carrier, the wireless communication method including: an equalization process of performing equalization processing on the pilot signal received from the transmission device and outputting a reception constellation; an indexing process of assigning an index predetermined for each signal point of a predetermined constellation to each convergence point of the reception constellation on the basis of each signal point of the predetermined constellation; a reference constellation calculation process of calculating each center of gravity of each cluster of the convergence points to which the same index has been assigned through the indexing process as a reference constellation to be referred to for demodulating the received signal; an estimation process of deleting a signal point regarded as an outlier from the reference constellation and estimating a model indicating distortion of a constellation; a correction process of correcting the constellation by adding the model estimated through the estimation process to an ideal constellation; and a demodulation process of demodulating the received signal using the constellation corrected through the correction process.

### Advantageous Effects of Invention

According to the present invention, it is possible to improve demodulation performance without reducing transmission capacity.

### BRIEF DESCRIPTION OF DRAWINGS

FIG. 1 is a diagram showing a configuration example of a wireless communication system according to an embodiment.

FIG. 2 is a functional block diagram illustrating functions of a transmission device.

FIG. 3(a) is a graph illustrating input/output characteristics of an amplification unit. FIG. 3(b) is a diagram illustrating a constellation of a transmission signal before being amplified by the amplification unit. FIG. 3(c) is a diagram illustrating a constellation of the transmission signal after being amplified by the amplification unit using a nonlinear region.

FIG. 4 is a functional block diagram illustrating functions of a reception device according to an embodiment.

FIG. 5 illustrates an overview of an operation of the reception device according to an embodiment.

FIG. 6 is a diagram showing a specific example of an operation of the reception device according to an embodiment.

FIG. 7 is a diagram showing a specific example of another operation of the reception device according to an embodiment.

### DESCRIPTION OF EMBODIMENTS

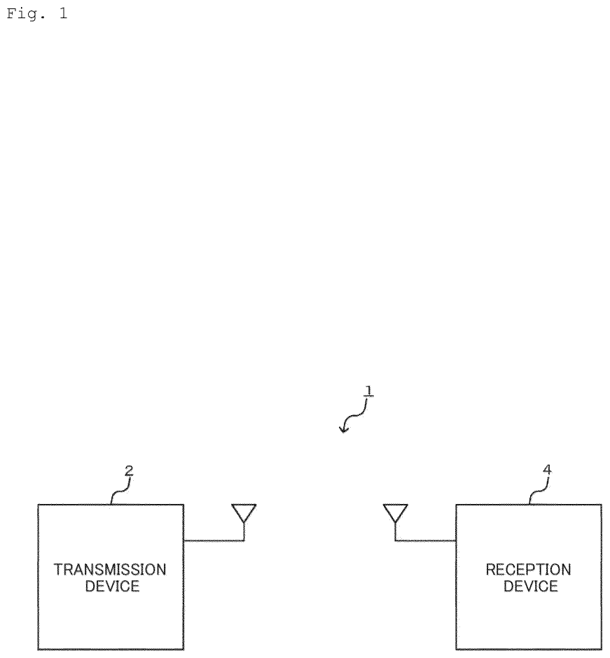

Hereinafter, an embodiment of a wireless communication system will be described using the drawings. FIG. 1 is a diagram showing a configuration example of a wireless communication system 1 according to an embodiment. The wireless communication system 1 is configured such that, for example, a transmission device 2 transmits a modulated digital signal amplified using a nonlinear region, and a reception device 4 receives and demodulates the digital signal.

Further, the transmission device 2 transmits a pilot signal for calculating communication channel information (for example, channel state information (CSI) ) to the reception device 4. The reception device 4 calculates communication channel information using the received pilot signal and transmits the calculated communication channel information to the transmission device 2. In addition, the reception device 4 demodulates a received signal on the basis of the pilot signal transmitted by the transmission device 2 using a single carrier.

The pilot signal may be transmitted until equalization processing which will be described later is performed, or may be transmitted every time equalization processing is performed periodically.

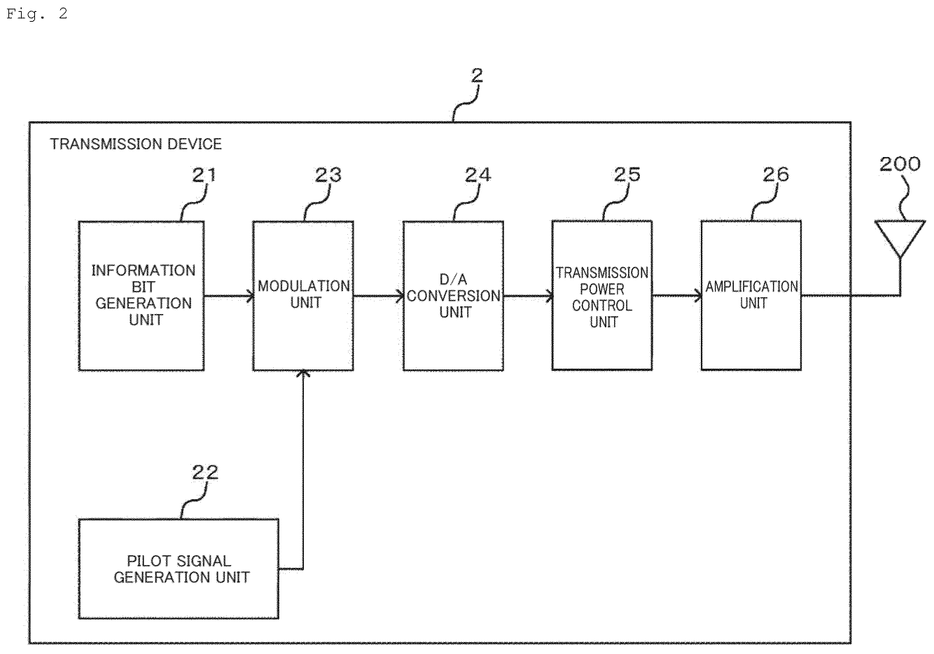

FIG. 2 is a functional block diagram illustrating functions of the transmission device 2. As shown in FIG. 2, the transmission device 2 includes an information bit generation unit 21, a pilot signal generation unit 22, a modulation unit 23, a D/A conversion unit 24, a transmission power control unit 25, an amplification unit 26, and an antenna 200.

The information bit generation unit 21 generates information bits to be transmitted to the reception device 4 and outputs the information bits to the modulation unit 23. Further, the information bit generation unit 21 may have an error correction coding function and an interleaving function.

The pilot signal generation unit 22 generates a pilot signal to be transmitted to the reception device 4 and outputs the pilot signal to a modulation unit 23. The pilot signal is, for example, an M series or the like used for estimation of a communication channel response, calculation of an equalization weight used for equalization processing, and the like, and is modulated by BPSK or QPSK.

The modulation unit 23 modulates the information bits generated by the information bit generation unit 21 into a data signal using, for example, a single carrier multi-value modulation method, and outputs the data signal to the D/A conversion unit 24. The single carrier multi-value modulation method performed by the modulation unit 23 includes, for example, BPSK, QPSK, and quadrature amplitude modulation such as 64QAM and 256QAM.

The D/A conversion unit 24 converts the data signal digitally modulated by the modulation unit 23 into an analog signal and outputs the analog signal to the transmission power control unit 25.

The transmission power control unit 25 controls a transmission power such that the data signal converted into the analog signal by the D/A conversion unit 24 has a desired communication quality.

The amplification unit 26 amplifies the analog signal converted by the D/A conversion unit 24 in accordance with control of the transmission power by the transmission power control unit 25 and radiates the amplified analog signal through the antenna 200.

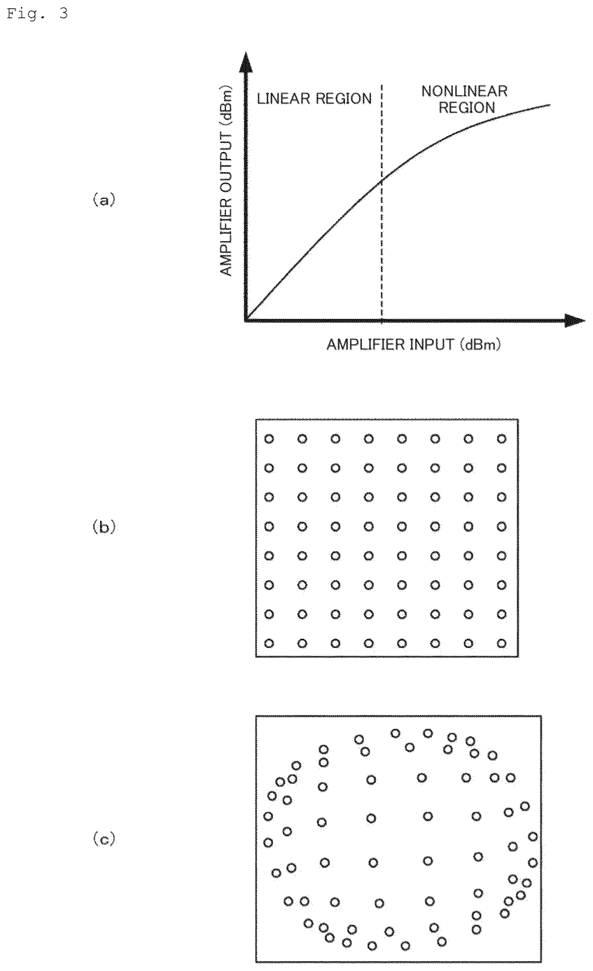

FIG. 3 is a diagram illustrating amplification characteristics of the amplification unit 26. FIG. 3(a) is a graph illustrating input/output characteristics (amplification characteristics) of the amplification unit 26. FIG. 3(b) is a diagram illustrating a constellation of a transmission signal before being amplified by the amplification unit 26. FIG. 3(c) is a diagram illustrating a constellation of the transmission signal after being amplified by the amplification unit 26 using a nonlinear region.

As illustrated in FIG. 3(a), the amplification unit 26 has a linear region for amplifying and outputting an input in proportion to the input, and a nonlinear region for nonlinearly amplifying an excessive input.

As shown in FIG. 3(b), no distortion occurs in the constellation of the transmission signal before being amplified by the amplification unit 26. Further, even when the amplification unit 26 amplifies the transmission signal using only a linear region, distortion does not occur in the constellation of the transmission signal. That is, FIG. 3(b) illustrates an ideal constellation without distortion.

On the other hand, as shown in FIG. 3(c), when the amplification unit 26 amplifies the transmission signal using a nonlinear region, distortion (amplitude reduction) occurs in the constellation.

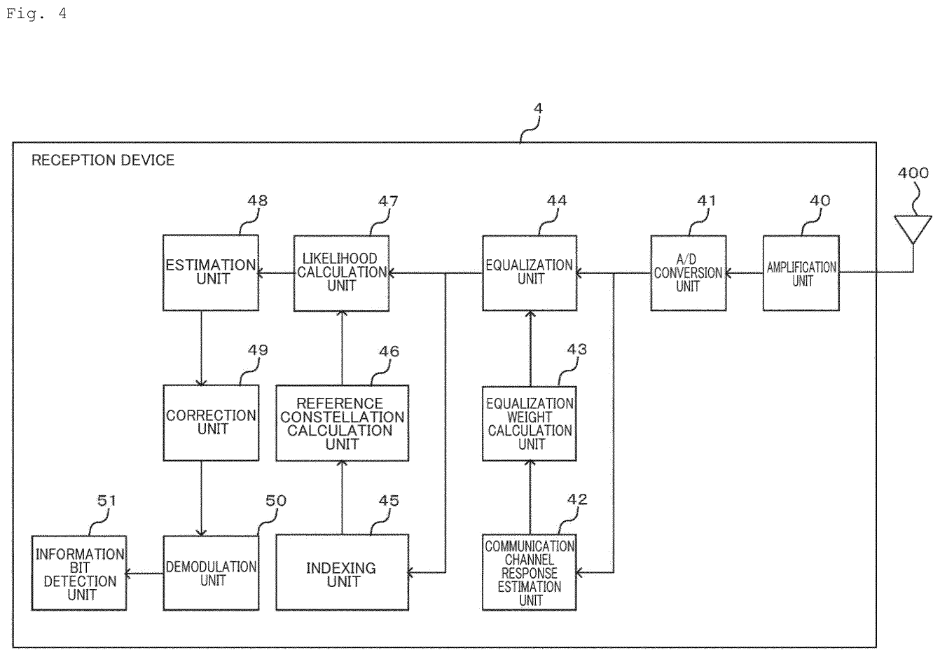

FIG. 4 is a functional block diagram illustrating functions of the reception device 4 according to an embodiment. As shown in FIG. 4, the reception device 4 according to an embodiment includes an antenna 400, an amplification unit 40, an A/D conversion unit 41, a communication channel response estimation unit 42, an equalization weight calculation unit 43, an equalization unit 44, an indexing unit 45, a reference constellation calculation unit 46, a likelihood calculation unit 47, an estimation unit 48, a correction unit 49, a demodulation unit 50, and an information bit detection unit 51.

The amplification unit 40 amplifies an analog signal received by the reception device 4 via the antenna 400 and outputs the amplified analog signal to the A/D conversion unit 41.

The A/D conversion unit 41 converts the analog signal amplified by the amplification unit 40 into a digital signal and outputs the digital signal to the communication channel response estimation unit 42 and the equalization unit 44. For example, the A/D conversion unit 41 converts the pilot signal transmitted by the transmission device 2 into a digital signal and outputs the digital signal to the communication channel response estimation unit 42. Further, the A/D conversion unit 41 of the reception device 4 converts a data signal corresponding to information bits to be transmitted from the transmission device 2 into a digital signal and outputs the digital signal to the equalization unit 44.

The pilot signal converted into a digital signal by the A/D conversion unit 41 is transmitted when the transmission device 2 and the reception device 4 start communication.

The communication channel response estimation unit 42 estimates a communication channel response on the basis of the pilot signal input from the A/D conversion unit 41.

The equalization weight calculation unit 43 calculates an equalization weight used by the equalization unit 44 on the basis of the communication channel response estimated by the communication channel response estimation unit 42.

The equalization unit 44 performs equalization processing using, for example, an inverse response of the communication channel response on the pilot signal received from the transmission device 2, and outputs a reception constellation. Specifically, the equalization unit 44 calculates an estimated value of a transmission signal by inversely calculating the amplitude and phase information of the communication channel response. Then, the equalization unit 44 outputs the result of equalization processing to the indexing unit 45 and the likelihood calculation unit 47.

The indexing unit 45 performs processing for assigning an index predetermined for each signal point of a predetermined constellation on each convergence point of the reception constellation output by the equalization unit 44 on the basis of each signal point of the predetermined constellation.

For example, the indexing unit 45 sets, as the predetermined constellation, an initial distorted constellation obtained by applying an initial value of nonlinear distortion of a constellation for wireless communication between the transmission device 2 and the reception device 4 to an ideal constellation without distortion.

The reference constellation calculation unit 46 calculates each center of gravity of each cluster of convergence points to which the same index has been assigned by the indexing unit 45 as a reference constellation to be referred to for demodulating a received signal and outputs the same to the likelihood calculation unit 47.

The likelihood calculation unit 47 calculates a likelihood of the reference constellation calculated by the reference constellation calculation unit 46 and outputs the likelihood to the estimation unit 48. The likelihood calculation unit 47 may perform hard decision or soft decision at the time of calculating a likelihood.

The estimation unit 48 deletes signal points regarded as outliers from the reference constellation for which the likelihood calculation unit 47 has calculated the likelihood, estimates a model indicating distortion of constellations, and outputs the model to the correction unit 49.

The correction unit 49 adds the model estimated by the estimation unit 48 to the ideal constellation to correct the constellation, and outputs the same to the demodulation unit 50.

The demodulation unit 50 demodulates a received signal using the constellation corrected by the correction unit 49 and outputs the same to the information bit detection unit 51.

The information bit detection unit 51 detects information bits from the signal demodulated by the demodulation unit 50. Further, the information bit detection unit 51 may have an error correction decoding function and a deinterleaving function.

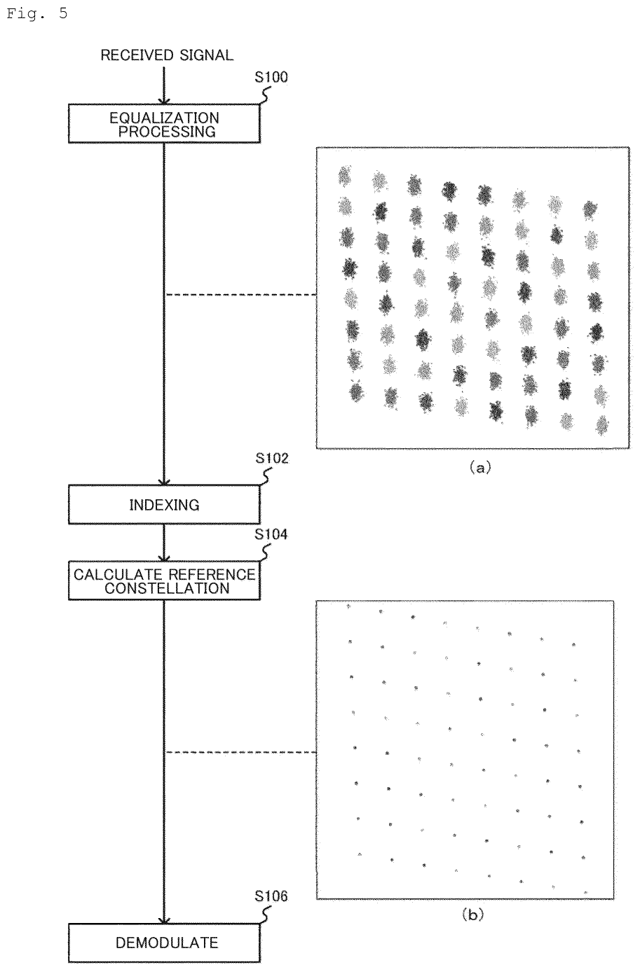

Next, an operation example of the reception device 4 will be described. FIG. 5 is a conceptual diagram showing an overview of an operation of the reception device 4 (FIG. 4) according to an embodiment.

In the reception device 4, the equalization unit 44 executes equalization processing on a received signal (S100). At this time, the equalization unit 44 outputs a reception constellation shown in (a) (equalization output).

Next, the indexing unit 45 performs processing (indexing) for assigning an index predetermined for each signal point of a predetermined constellation to each convergence point of the reception constellation output by the equalization unit 44 on the basis of each signal point of the predetermined constellation (S102).

The reference constellation calculation unit 46 performs clustering using a clustering algorithm such as k-means clustering, for example, to classify each convergence point to which the same index has been assigned, for example.

Then, the reference constellation calculation unit 46 calculates each center of gravity of each cluster of convergence points to which the same index has been assigned by the indexing unit 45 as a reference constellation shown in (b) (S104). That is, the reference constellation calculated by the reference constellation calculation unit 46 is a constellation in which distortion in wireless communication is reflected with respect to an ideal constellation.

The reference constellation calculation unit 46 may use an ideal constellation that does not consider distortion as an initial center of gravity, or may use a constellation obtained by multiplying the ideal constellation by nonlinear distortion in accordance with, for example, input/output characteristics of an amplifier, as the initial center of gravity.

Thereafter, the demodulation unit 50 demodulates the received signal on the basis of the reference constellation calculated by the reference constellation calculation unit 46 (S106).

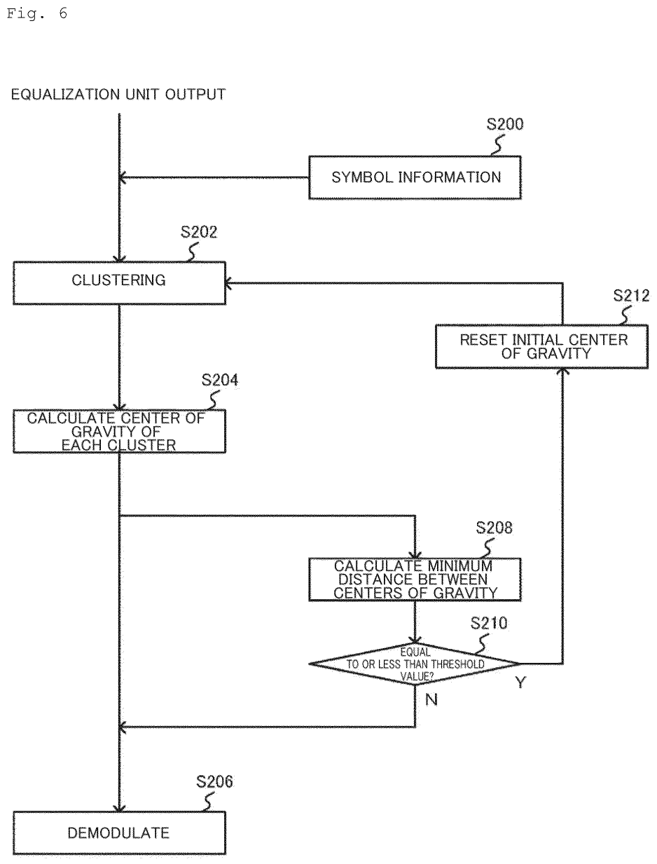

FIG. 6 is a diagram showing a specific example of an operation of the reception device 4 according to an embodiment. As shown in FIG. 6, the reception device 4 uses symbol information of the constellation for the output of the equalization unit 44 (S200) and performs clustering of convergence points of the reception constellation (S202).

For example, the reception device 4 uses an MCS index or the like as symbol information to detect the number k of candidates for symbol mapping and an ideal reference point position. The reception device 4 may estimate the number k of candidates for symbol mapping by performing blind estimation.

Further, at the time of performing clustering of convergence points of the reception constellation, the reception device 4 performs k-means clustering until convergence, for example, with the ideal reference point position as an initial center of gravity. The initial center of gravity may be determined by randomly selecting k signal points from received signal points, or may be determined by multiplying an ideal constellation by known device specifications or a general distortion model (for example, an amplified distortion model such as a Rapp model).

Then, the reception device 4 calculates the center of gravity of each cluster (S204) and demodulates the received signal using each center of gravity as a reference constellation (S206).

At this time, the reception device 4 calculates the minimum distance between the centers of gravity as the reference constellations (S208) and determines whether or not the minimum distance between the centers of gravity is equal to or less than a predetermined threshold value (S210). Processing proceeds to S212 in a case where the minimum distance between the centers of gravity is equal to or less than the predetermined threshold value (S210: Yes) and processing proceeds to S206 in other cases (S210: No).

The reception device 4 may use the maximum value or average value of Euclidean distances between ideal reference point position and the center of gravity points when the threshold value is determined.

The reception device 4 resets the initial center of gravity for performing clustering in processing of S212 and returns to processing of S202. The initial center of gravity to be reset in processing of S212 may be determined by multiplying an ideal constellation by known device specifications or a general distortion model (for example, an amplified distortion model such as a Rapp model).

The frequency of updating the reference constellation by the reception device 4 by the operation shown in FIG. 6 may be variable or fixed.

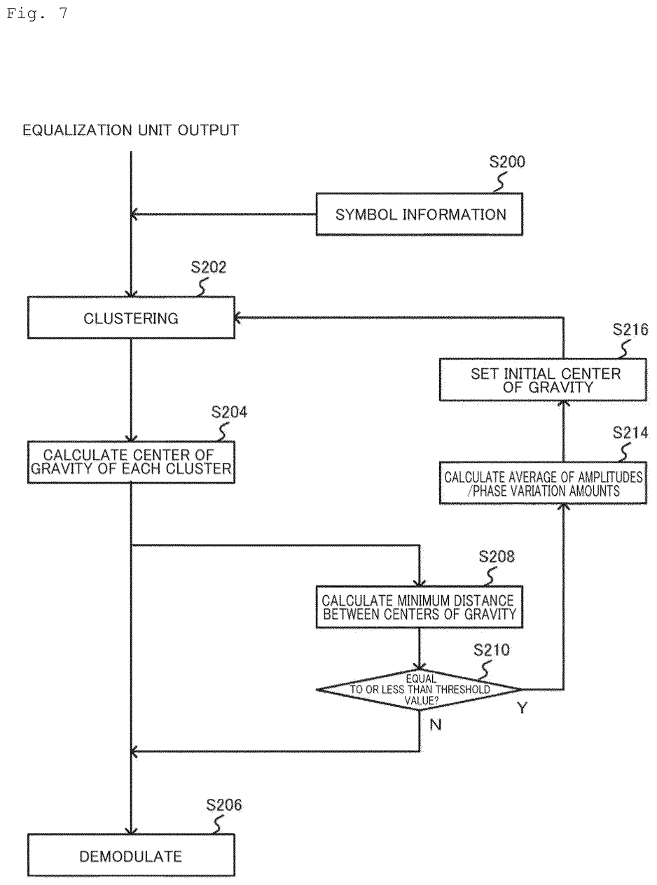

FIG. 7 is a diagram showing a specific example of another operation of the reception device 4 according to an embodiment. In the specific example of another operation of the reception device 4 shown in FIG. 7, substantially the same processing as the specific example of the operation of the reception device 4 shown in FIG. 6 is denoted by the same reference numeral.

The reception device 4 proceeds to processing of S214 in a case where the minimum distance between the centers of gravity is equal to or less than the predetermined threshold value (S210: Yes), and proceeds to processing of S206 in the other cases (S210: No).

The reception device 4 calculates the average of amplitudes and phase variation amounts of the signal points from the ideal reference point position in processing of S214. At this time, the reception device 4 may delete an outlier having a variation amount exceeding a predetermined threshold value from processing targets. For example, when there are three outlier signal points, the reception device 4 assumes that 61 signal points will be a reference constellation in which proper variation due to actual IQ imbalance has been performed and calculates amplitudes and phase variation amounts of the 61 signal points.

In processing of S216, the reception device 4 adds the calculated amplitude and phase variation amount of each signal point to the ideal constellation, sets the same as an initial center of gravity, and returns to processing of S202. At this time, the reception device 4 may perform interpolation or extrapolation on outlier signal points on the basis of the positions (center of gravity positions) of other signal points to create a constellation that includes all signal points.

In this way, the reception device 4 according to an embodiment calculates the average of amplitudes and phase variation amounts of signal points from an ideal reference point position on the basis of a reception constellation, corrects the constellation, and demodulates a received signal, and thus it is possible to improve demodulation performance without reducing transmission capacity.

Further, the reception device 4 may compensate for the coordinate position of each outlier signal point by interpolating or extrapolating the same from the coordinate positions of surrounding signal points, and may perform processing for setting all signal points as initial centers of gravity. In this case, the reception device 4 can also correct nonlinear distortion of a constellation.

That is, the wireless communication system 1 can improve the demodulation performance of the reception device 4, for example, even when the amplification unit 26 of the transmission device 2 has nonlinear distortion. Further, the wireless communication system 1 does not require a control signal for notifying the reception device 4 of the nonlinear distortion characteristic of the amplification unit 26 and thus can prevent transmission capacity from being reduced.

Further, some or all of the units constituting the transmission device 2 and the reception device 4 in the above-described embodiment may be configured as hardware, or may be configured by causing a processor to execute a program.

In addition, in a case where some or all of the units constituting the transmission device 2 and the reception device 4 are configured by causing a processor to execute a program, the program may be recorded on a recording medium and provided, or may be provided via a network.

Although the above-described embodiment has been described with reference to a case of compensating for IQ imbalance, the wireless communication system 1 can improve demodulation performance without reducing transmission capacity for all distortions that cause contraction/rotation of a constellation without random variation within a radio frame (e.g., a case where there is nonlinear distortion in an amplifier, and the like). The wireless communication system 1 is not limited to an antenna configuration such as SISO/MIMO, a system configuration, and the like.

### REFERENCE SIGNS LIST

1 Wireless communication system
2 Transmission device
4 Reception device
21 Information bit generation unit
22 Pilot signal generation unit
23 Modulation unit
24 D/A conversion unit
25 Transmission power control unit
26 Amplification unit
40 Amplification unit
41 A/D conversion unit
42 Communication channel response estimation unit
43 Equalization weight calculation unit
44 Equalization unit
45 Indexing unit
46 Reference constellation calculation unit
47 Likelihood calculation unit
48 Estimation unit
49 Correction unit
50 Demodulation unit
51 Information bit detection unit
200, 400 Antenna

1. A wireless communication system in which a reception device demodulates a received signal on the basis of a pilot signal transmitted by a transmission device using a single carrier,
wherein the reception device comprises:
equalization circuitry configured to perform equalization processing on the pilot signal received from the transmission device and output a reception constellation;
indexing circuitry configured to assign an index predetermined for each signal point of a predetermined constellation to each convergence point of the reception constellation on the basis of each signal point of the predetermined constellation;
reference constellation calculation circuitry configured to calculate each center of gravity of each cluster of the convergence points to which the same index has been assigned by the indexing circuitry as a reference constellation to be referred to for demodulating the received signal;
estimation circuitry configured to delete a signal point regarded as an outlier from the reference constellation and estimate a model indicating distortion of a constellation;
correction circuitry configured to correct the constellation by adding the model estimated by the estimation circuitry to an ideal constellation; and
demodulation circuitry configured to demodulate the received signal using the constellation corrected by the correction circuitry.

2. The wireless communication system according to claim 1, wherein the indexing circuitry set, as the predetermined constellation, an initial distorted constellation obtained by applying an initial value of nonlinear distortion of a constellation for wireless communication between the transmission device and the reception device to an ideal constellation without distortion.

3. A reception device comprising:
equalization circuitry configured to perform equalization processing on a pilot signal transmitted from a transmission device using a single carrier and output a reception constellation;
indexing circuitry configured to assign an index predetermined for each signal point of a predetermined constellation to each convergence point of the reception constellation on the basis of each signal point of the predetermined constellation;
reference constellation calculation circuitry configured to calculate each center of gravity of each cluster of the convergence points to which the same index has been assigned by the indexing circuitry as a reference constellation to be referred to for demodulating the received signal;
estimation circuitry configured to delete a signal point regarded as an outlier from the reference constellation and estimate a model indicating distortion of a constellation;
correction circuitry configured to correct the constellation by adding the model estimated by the estimation circuitry to an ideal constellation; and
demodulation circuitry configured to demodulate the received signal using the constellation corrected by the correction circuitry.

4. The reception device according to claim 3, wherein the indexing circuitry set, as the predetermined constellation, an initial distorted constellation obtained by applying an initial value of nonlinear distortion of a constellation for wireless communication with the transmission device to an ideal constellation without distortion.

5. A wireless communication method in which a reception device demodulates a received signal on the basis of a pilot signal transmitted by a transmission device using a single carrier, the wireless communication method comprising:
performing equalization processing on the pilot signal received from the transmission device and outputting a reception constellation;
assigning an index predetermined for each signal point of a predetermined constellation to each convergence point of the reception constellation on the basis of each signal point of the predetermined constellation;
calculating each center of gravity of each cluster of the convergence points to which the same index has been assigned through the assigning as a reference constellation to be referred to for demodulating the received signal;
deleting a signal point regarded as an outlier from the reference constellation and estimating a model indicating distortion of a constellation;
correcting the constellation by adding the model estimated through the deleting to an ideal constellation; and
demodulating the received signal using the constellation corrected through the correcting.

6. The wireless communication method according to claim 5, wherein, in the assigning, an initial distorted constellation obtained by applying an initial value of nonlinear distortion of a constellation for wireless communication between the transmission device and the reception device to an ideal constellation without distortion is set as the predetermined constellation.

7. A non-transitory computer-readable storage medium storing a reception program for causing a computer to function as each circuitry of the reception device according to claim 3.
